(19) United States
(12) Patent Application Publication
(10) Pub. No.: US 2016/0020863 A1
(43) Pub. Date: Jan. 21, 2016

(54) Method and apparatus for providing black box service for vehicle diagnosis using in-vehicle time synchronization message

(71) Applicants: Hyundai Motor Company, Seoul (KR); Kia Motors Corporation, Seoul (KR); IUCF-HYU (Industry-University Cooperation Foundation Hanyang University), Seoul (KR)

(72) Inventors: Seung Su Kim, Seoul (KR); Seong Jin Park, Daejeon (KR); Woo Sub Kim, Namyangju (KR); Ho Yoo, Suwon Gyeonggi-Do (KR); Chung Hi Lee, Seoul (KR); Sung Kwon Park, Seoul (KR); Ju Ho Lee, Seoul (KR); Young Hwan Jeon, Yongin (KR)

(21) Appl. No.: 14/526,383

(22) Filed: Oct. 28, 2014

(30) Foreign Application Priority Data
Jul. 16, 2014 (KR) 10-2014-0089487

(51) Int. Cl. H04J 3/06; G07C 5/00; G07C 5/08; H04L 12/24; H04L 29/06

(52) U.S. Cl. CPC H04J 3/0658; H04L 41/0677; H04L 69/22; G07C 5/0808; G07C 5/0841; G07C 5/006

(57) ABSTRACT

A method for providing a black box service for vehicle diagnosis and an apparatus and system therefor are disclosed herein. A method for providing a black box service for vehicle diagnosis in an in-vehicle apparatus connected to a network includes confirming whether or not a time synchronization message including a black box address is received, updating status information in the apparatus, when the time synchronization message is received as a result of confirmation, and transmitting a status information message including the updated status information to the black box address set as a destination address. Therefore, a more stable black box service for vehicle diagnosis is provided.

### CROSS-REFERENCE TO RELATED APPLICATION

This application claims the benefit of Korean Patent Application No. 10-2014-0089487, filed on Jul. 16, 2014, which is hereby incorporated by reference as if fully set forth herein.

### BACKGROUND

1. Technical Field

The present disclosure relates to a black box for vehicle diagnosis, and more particularly, to a method for providing a black box service for vehicle diagnosis using an in-vehicle time synchronization message and an apparatus therefor.

2. Discussion of the Related Art

Vehicles which have been recently released are loaded with various electronic control apparatuses to improve driver convenience and safety. Further, many such vehicles are loaded with an in-vehicle communication network for mutual communication between these electronic control apparatuses.

Particularly, Ethernet is widely used as the in-vehicle communication network. Ethernet generally includes a plurality of local area networks (LANs) and a plurality of bridges for connection between the LANs. Ethernet is characterized in that a plurality of nodes competitively attempts to approach a shared medium using a Carrier Sense Multiple Access/Collision Detection (CSMA/CD) protocol. However, since the same priority is granted to all traffic, and the plurality of nodes transmits traffic thereof through competition, such a CSMA/CD method is not suitable for transmission of multimedia data sensitive to transmission time delay, such as video or audio data. Therefore, Ethernet synchronizes times of all nodes on a network for transmission of multimedia data sensitive to transmission time delay.

Recently, IEEE 802.1 is developing an audio/video bridge (AVB) standard. The AVB standard can be utilized to develop a transmission quality guarantee for effectively transmitting a multimedia stream including audio and video on a LAN. As described above, a basic Ethernet-enabled LAN often uses a frame-based packet switching technique, and thus has difficulty in guaranteeing an effective transmission quality.

In order to solve such a problem, IEEE 802.1 researches a method of implementing similar techniques using a bridge without damaging the paradigm of conventional asynchronous packet switching. Basically, the AVB technique, of IEEE 802.1 enables synchronous traffic transmission using conventional Ethernet bridges performing packet switching and synchronizes clocks of bridges within a designated geographic category. When clocks of the bridges are synchronized, Ethernet frames having a regular size may be transmitted between the bridges at a correct desired time by regular time intervals. Therefore, a bridge mesh employing such a basic concept may be used as an infrastructure to stably transmit synchronous traffic.

For example, an IEEE 1588 Precision Time Protocol (PTP) is a time synchronization standard which may be operated in the entirety of Open System Interconnection (OSI) layers, and IEEE 802.1AS is a time synchronization standard which supports only the profile of an OSI second layer, i.e., a data link layer, based on IEEE 1588. If IEEE 802.1AS is applied to apparatuses of the OSI second layer, such as bridges, switches, etc., an OSI second layer time synchronization network may be formed.

A method for synchronizing times between respective apparatuses of IEEE 802.1AS synchronizes times of a transmitting side and a receiving side using timestamps including time synchronization information. A grandmaster (GM) providing a reference time for time synchronization is selected from among apparatuses in a network, and a local time of the selected grandmaster is transmitted to other apparatuses through an announce message so that these apparatuses use the local time of the grandmaster as the reference time. Here, the grandmaster transmits the announce message to all other apparatuses, and thus transmits presence thereof and a comparison value regarding appropriateness thereof as a reference time for all other apparatuses. That is, the grandmaster is the uppermost node of an IEEE 802.1AS timing tree which periodically transmits current time information to lower nodes.

Furthermore, IEEE 802.1AS defines a procedure of determining a grandmaster and acquiring time synchronization, a procedure of searching all apparatuses in a network and controlling approach to links using a plurality of control messages, and a procedure of continuously confirming link states through an announce message. However, IEEE 802.1AS does not disclose a method for acquiring diagnosis information of all apparatuses in the network and effectively managing the apparatuses.

### SUMMARY

Accordingly, the present disclosure is directed to a method and apparatus for providing a black box service for vehicle diagnosis using an in-vehicle time synchronization message that substantially obviates one or more problems due to limitations and disadvantages of the related art.

An object of the present disclosure is to provide a method for providing a black box service for vehicle diagnosis using an in-vehicle time synchronization message. Another object of the present disclosure is to provide a method for providing a black box service for vehicle diagnosis which may perform continuous and safe vehicle diagnosis, as well as time synchronization, by adding a message format for diagnosis to a precision time protocol (PTP) procedure defined in IEEE 802.1AS. Another object of the present disclosure is to provide a recording method of a black box for vehicle diagnosis which may perform self-vehicle diagnosis and post-analysis by adding a format for diagnosis to an announce message between apparatuses using the same time source. Yet another object of the present disclosure is to provide a method for collecting vehicle diagnosis information which may diagnose all apparatuses in a vehicle and record results of diagnosis without definition of a separate new procedure by adding information for vehicle diagnosis to an announce message conventionally used for time synchronization.

Additional advantages, objects, and features of the disclosure will be set forth in part by the description which follows and will become apparent to those having ordinary skill in the art upon examination of the following, or may be learned from practice of the disclosure. The objectives and other advantages of the disclosure may be realized and attained by the structure particularly pointed out in the written description and claims hereof, as well as the appended drawings.

To achieve these objects and other advantages and in accordance with the purpose of the disclosure, as embodied and described herein, a method for providing a black box service for vehicle diagnosis in an in-vehicle apparatus connected to a network includes: confirming whether or not a time synchronization message including a black box address is received, updating status information in the in-vehicle apparatus when the time synchronization message is received as a result of confirmation, and transmitting a status information message including the updated status information to the black box address set as a destination address.

The time synchronization message may be generated by a grandmaster.

The time synchronization message may be received through a bridge connected to the grandmaster.

The black box address may be provided to the grandmaster by the bridge.

The time synchronization message may be formed by adding a field of the black box address to one side of an announce message format defined in IEEE 802.1AS.

The status information message may further include at least one of apparatus identifier information to identify the in-vehicle apparatus, type information to identify the kind of the in-vehicle apparatus, and last update time information indicating a time when the time synchronization message has been last received.

The kind of the in-vehicle apparatus may be one of a switch, an electronic control unit (ECU), and a grandmaster.

The method may further include transmitting a status information message indicating whether the in-vehicle apparatus requires repair to the black box address set as the destination address, when the time synchronization message is not received for a designated time.

The status information may be set to a value corresponding to one of a normal state, a port error state, a response delay state, a power error state, and a repair requirement state.

The port error state, the response delay state, and the power error state may be options selectable according to an option setting.

The method, when there is another apparatus connected to the in-vehicle apparatus, may further include transmitting the time synchronization message to the in-vehicle apparatus through a slave port of the other apparatus.

The black box address may be a media access control (MAC) address.

In another aspect of the present disclosure, a method for providing a black box service for vehicle diagnosis in a black box connected to an in-vehicle apparatus through a network, includes: transmitting address information of the black box indicating a black box address to a bridge, receiving a status information message from the in-vehicle apparatus through the bridge, and updating a diagnosis information table according to kinds of the in-vehicle apparatus using the status information message, wherein, when the in-vehicle apparatus receives a time synchronization message generated by a grandmaster, the in-vehicle apparatus generates the status information message.

The kinds of the in-vehicle apparatus may include a switch, an electronic control unit (ECU), and a grandmaster.

The status information message may include at least one of apparatus identifier information to identify the in-vehicle apparatus, type information to identify the kind of the in-vehicle apparatus, last update time information indicating a time when the time synchronization message has been last received, status information indicating the current status of the in-vehicle apparatus, and destination address information indicating a destination address receiving the status information message, wherein the destination address is set according to the address information of the black box.

The status information may be set to a value corresponding to one of a normal state, a port error state, a response delay state, a power error state, and a repair requirement state.

The time synchronization message may be formed by adding a field of the black box address to one side of an announce message format defined in IEEE 802.1AS.

The method may further include receiving a status information table request message from a diagnostic apparatus and transmitting the diagnosis information table to the diagnostic apparatus.

In another aspect of the present disclosure, a computer readable recording medium having a program recorded thereon to implement the method is provided.

In another aspect of the present disclosure, an apparatus connected to an in-vehicle network and using the same time information includes: a unit to confirm whether or not a time synchronization message including a black box address is received, a unit to update status information in the in-vehicle apparatus when the time synchronization message is received as a result of confirmation, and a unit to transmit a status information message including the updated status information to the black box address set as a destination address.

In another aspect of the present disclosure, a black box connected to an in-vehicle apparatus using the same time information through a network includes: a unit to transmit address information of the black box indicating a black box address to a bridge, a unit to receive a status information message from the in-vehicle apparatus through the bridge, and a unit to update a diagnosis information table according to kinds of the in-vehicle apparatus using the status information message, wherein, when the in-vehicle apparatus receives a time synchronization message generated by a grandmaster, the apparatus generates the status information message.

In yet another aspect of the present disclosure, a system for providing a black box service for vehicle diagnosis includes a grandmaster generating a time synchronization message including a black box address by designated periods and transmitting the time synchronization message, an in-vehicle apparatus updating status information thereof, when the time synchronization message is received, and transmitting a status information message including the updated status information to the black box address set as a destination address, and a black box receiving the status information message from the in-vehicle apparatus and updating a diagnosis information table.

The system may further include a diagnostic apparatus transmitting a status information table request message to the black box and receiving the diagnosis information table.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a view illustrating a conventional message header defined in IEEE 802.1AS;

FIG. 2 is a view illustrating the structure of a conventional announce message defined in IEEE 802.1AS;

FIG. 3 is a view illustrating a conventional announce message comparison procedure and port allocation method in IEEE 802.1AS;

FIG. 4 is a view illustrating a conventional time synchronization procedure in IEEE 802.1AS;

FIG. 5 is a flowchart illustrating a conventional grandmaster selection and announce message transmission procedure;

FIG. 6 is a view illustrating the structure of a time synchronization message in accordance with one embodiment of the present disclosure;

FIG. 7 is a view illustrating the structure of a black box system for vehicle diagnosis in accordance with one embodiment of the present disclosure;

FIG. 8 is a view illustrating the structure of a status information message in accordance with one embodiment of the present disclosure;

FIG. 9 is a status information mapping table in accordance with one embodiment of the present disclosure;

FIG. 10 is a black box diagnosis information table in accordance with one embodiment of the present disclosure;

FIG. 11 is a flowchart illustrating a black box recording and diagnosis procedure through a status information message in accordance with one embodiment of the present disclosure; and

FIG. 12 is a flowchart illustrating a method for providing a black box service for vehicle diagnosis using an in-vehicle time synchronization message in accordance with one embodiment of the present disclosure.

### DETAILED DESCRIPTION OF THE EMBODIMENTS

Reference will now be made in detail to the preferred embodiments of the present disclosure, examples of which are illustrated in the accompanying drawings. The suffixes “module” and “unit” in elements used in the description below are given or used together only in consideration of ease in preparation of the specification and do not have distinctive meanings or functions.

Hereinafter, although one embodiment of the present disclosure illustrates all elements as being combined, embodiments of the present disclosure are not limited thereto. That is, one or more of all the elements may be selectively combined within the scope of the disclosure. Further, all the elements may be respectively implemented by independent pieces of hardware, or some of the elements of all the elements may be selectively combined and thus implemented by a computer program having a program module performing the functions of the combined elements in a plurality of pieces of hardware. Codes and code segments constituting the computer program may be easily deduced by those skilled in the art. Such a computer program is stored in a computer readable storing medium and read and operated by a computer, thus being capable of implementing embodiments of the present disclosure. The storing medium of the computer program may include a magnetic recording medium, an optical recording medium, a carrier wave medium, etc.

Further, it will be understood that the term “including”, “constituting”, or “having” in the description means that a corresponding element may be included and other elements than the element may be further included. It will be understood that all terms including technical or scientific terms have the same meanings as those generally understood by those skilled in the art. The generally used terms, such as the terms defined in a dictionary, may be interpreted as having meanings coinciding with the meanings used in the art, and may not be interpreted as having ideal or excessively formal meanings.

Further, in description of elements of the present disclosure, the terms “first”, “second”, “(a)”, “(b)”, etc. may be used. These terms are used only to discriminate an element from other elements, and the nature, order, or sequence of the corresponding element is not limited by these terms. If it is stated that an element is “connected to”, “combined with”, or “coupled with” another element, it will be understood that the former may be directly connected to or combined with the latter or other elements may be intervened between the two elements.

Moreover, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

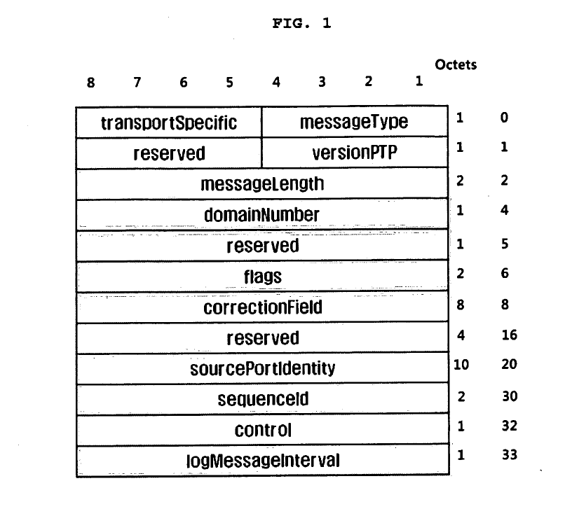

Hereinafter, a conventional time synchronization method defined in IEEE 802.1AS will be described in brief with reference to FIGS. 1 to 5.

IEEE 802.1AS defines header structures of messages used for network time synchronization, a structure of an announce message, a method for selecting a grandmaster providing reference time information, and a method for allocating respective port roles in switches.

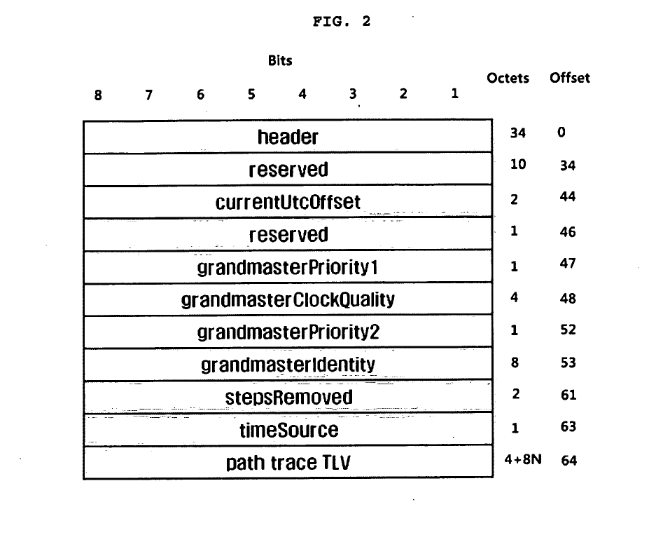

FIG. 1 is a view illustrating a conventional message header defined in IEEE 802.1AS and FIG. 2 is a view illustrating the structure of a conventional announce message defined in IEEE 802.1AS. An announce message may include information required to select a grandmaster, such as currentUtcOffset, grandmasterPriority1, grandmasterPriority2, grandmasterClockQuality, gransmasterIdentity, etc. Hereinafter, for convenience of description, the information required to select a grandmaster will be referred to as reference time information.

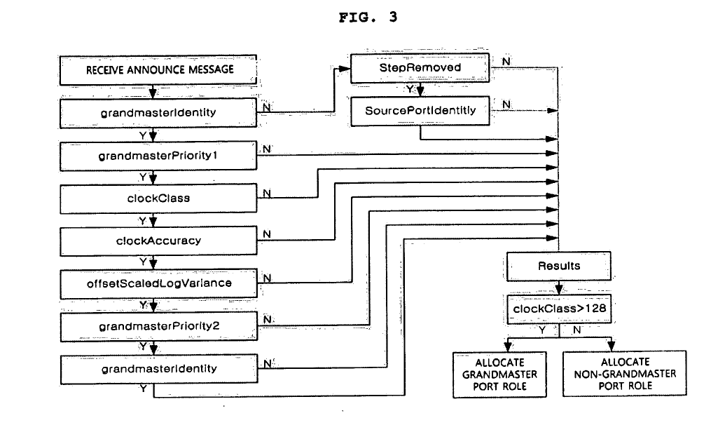

FIG. 3 is a view illustrating a conventional announce message comparison procedure and port allocation method in IEEE 802.1AS. Each of all qualified apparatuses on a network may form an announce message including reference time information thereof and then transmit the announce message to other apparatuses. Here, an apparatus having a clock of the best quality may be selected as a grandmaster. When each apparatus receives announce messages from other apparatuses, the apparatus may compare reference time information included in the received announce messages and its own reference time information and select an apparatus having the highest priority and accuracy as its own grandmaster. Of course, if the reference time of the corresponding apparatus is more accurate than the reference times of other apparatuses, the corresponding apparatus may judge itself as a grandmaster.

All ports of an apparatus selected as a grandmaster serve to transmit reference time information to other apparatuses. Hereinafter, for convenience, of description, ports used to transmit reference time information of the grandmaster will be defined as master ports. On the other hand, ports of other apparatuses connected to the master ports and used to receive the reference time information of the grandmaster will be defined as slave ports.

As shown in FIG. 3, when each apparatus receive an announce message, the corresponding apparatus may compare reference time information of the received announce message, including grandmasterIdentity, grandmasterPriority1, clockclass, clockAccuracy, of fsetScaledLogVariance, grandmasterPriority2, grandmasterIdentity, StepRemoved, and SourcePortIdentity, with its own reference time information and judge which apparatus is selected as a grandmaster. For example, when an apparatus A judges that itself is selected as a grandmaster, the apparatus A allocates its all ports as master ports. On the other hand, when the apparatus A judges that another apparatus is selected as a grandmaster, the apparatus A allocates its all ports as slave ports.

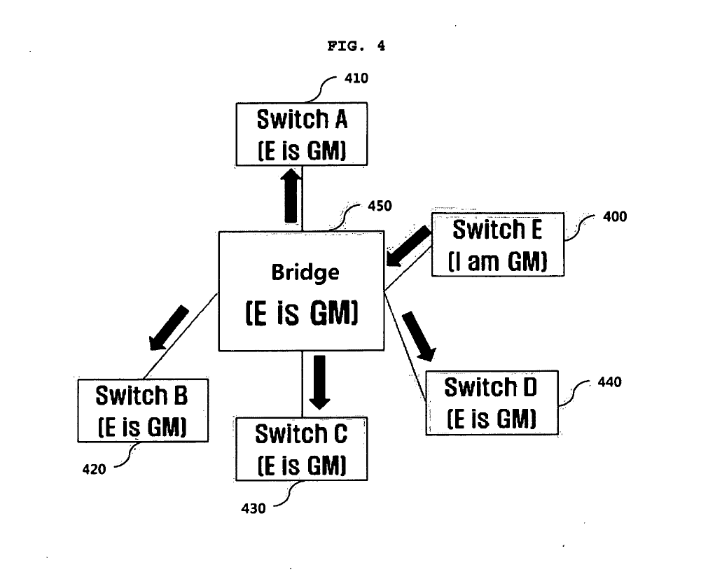

FIG. 4 is a view illustrating a conventional time synchronization procedure in IEEE 802.1AS. In more detail, FIG. 4 is a view illustrating a time synchronization procedure in a star topology network structure using a bridge.

In general, a bridge is a network connection device to interconnect two local area networks (LANs) and is operated in a data link layer of an OSI reference model. The bridge may be used (1) when the range and length of a communication network are increased, (2) when a larger number of apparatuses is connected to a communication network, (3) when bottlenecks due to an excessively large number of apparatuses connected to a communication network need to be reduced, (4) when communication networks including different physical media (e.g., communication lines) need to be connected, and (5) when communication network structures having different topologies, such as Ethernet and token rings, need to be connected.

With reference to FIG. 4, it is assumed that a switch E 400 is selected as a grandmaster through an initial time synchronization procedure. The switch E 400 may periodically generate an announce message including its own reference time information and transmit the announce message to a bridge 450. Thereafter, the bridge 450 may transmit the received announce message to a switch A410, a switch B 420, a switch C 430, and a switch D 440. Particularly, the bridge 450 may analyze time information included in received announce messages, detect a switch providing the most accurate time information, and transmit only the announce message received from the detected switch to slave nodes.

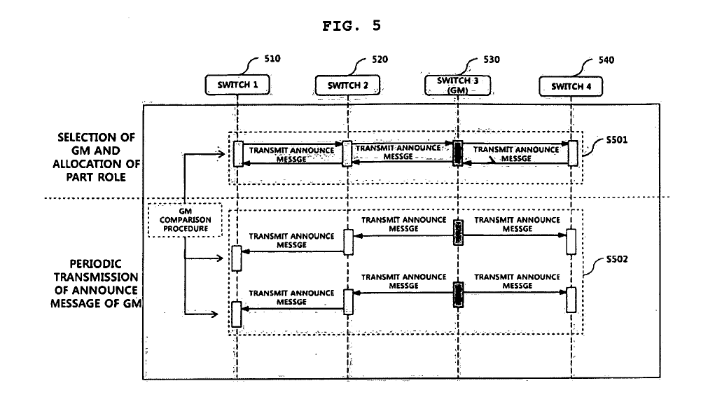

FIG. 5 is a flowchart illustrating a conventional grandmaster selection and announce message transmission procedure. With reference to FIG. 5, a switch 1 510, a switch 2 520, a switch 3 530, and a switch 4 540 transmit announce messages to the switches connected thereto, a grandmaster is selected through a reference time information comparison procedure of the respective switches 1 to 4 510 to 540, and roles of ports of the switches 1 to 4 510 to 540 are allocated according to results of selection (Operation S501). As exemplarily shown in FIG. 5, it is assumed that the switch 3 530 is selected as a grandmaster.

Thereafter, the switch 3 530 generates an announce message periodically, for example, by a period of 1 second, transmits the announce message to the switch 2 520 and the switch 4 540 through master ports, and the switch 2 520 transmits the received announce message to the switch 1 510 through its own slave ports (Operation S502). That is, an apparatus selected as the grandmaster may inform other apparatuses of the presence of the grandmaster and superiority of its own reference time.

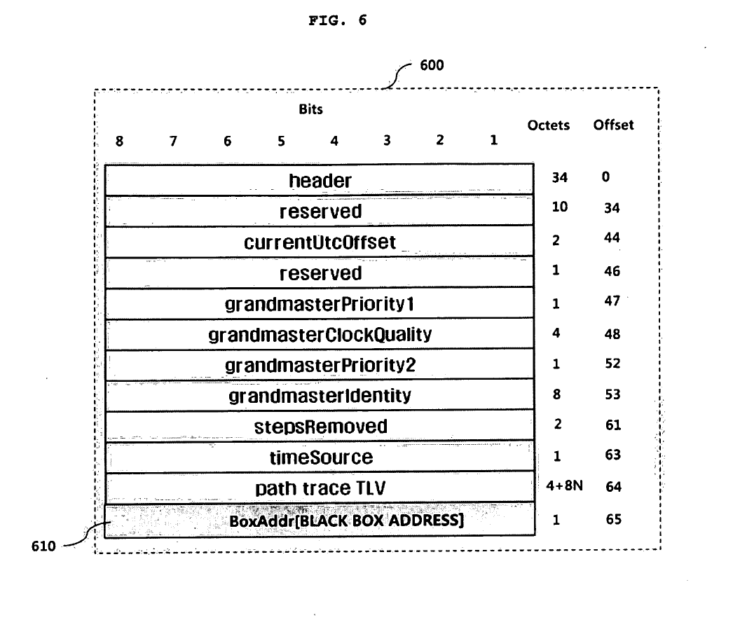

FIG. 6 is a view illustrating the structure of a time synchronization message in accordance with one embodiment of the present disclosure. Hereinafter, for convenience of description, a time synchronization message and an announce message may be used together.

With reference to FIG. 6, a time synchronization message 600 may be acquired by adding the field of a black box address (BoxAddr) 610 for diagnosis to the announce message of FIG. 2. An apparatus selected as a grandmaster may transmit an announce message including a black box address to all slave apparatuses using the same time source, and the slave apparatuses may update inner status information, set a destination address as the black box address, and transmit the updated status information to a corresponding black box. Here, the black box address 610 may be a MAC address assigned to a black box.

Although FIG. 6 illustrates the field of the black box address 610 as being added to the end part of a payload region of the conventional announce message, this is only one embodiment and is not intended to limit the scope of the present disclosure. For example, in accordance with another embodiment of the present disclosure, the black box address 610 may be transmitted using a reserved field included in the conventional announce message.

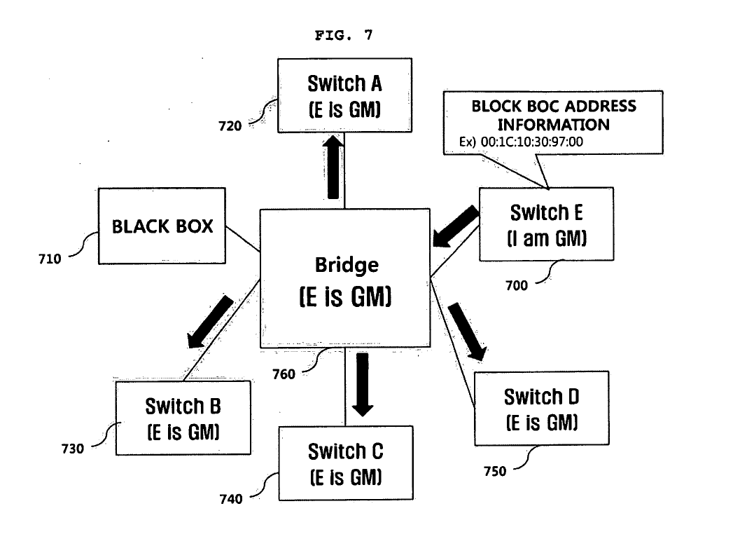

FIG. 7 is a view illustrating the structure of a black box system for vehicle diagnosis in accordance with one embodiment of the present disclosure. With reference to FIG. 7, a black box system for vehicle diagnosis may have a star topology and include a bridge 760, and a plurality of switches 700, 720, 730, 740, and 750 and a black box 710 connected to the bridge 760.

The bridge 760 may maintain MAC address information of the black box 710 connected thereto and provide the MAC address information to a selected grandmaster. For example, the black box 710 may transmit its own MAC address to the bridge 760 to which the black box 710 is connected through a designated control procedure. Also, the bridge 760, when a grandmaster is selected, may transmit the received MAC address of the black box 710 to the grandmaster. That is, the bridge 760, whenever a new grandmaster is selected, may transmit the MAC address information of the black box 710 to the newly selected grandmaster. If the switch E 700 is selected as a grandmaster through an initial time synchronization procedure, the switch E 700 periodically transmits an announce message including black box information to the bridge 760.

Thereafter, the bridge 760 transmits the received announce message to all the switches 720 to 750 connected thereto. The switches 720 to 750 having received the announce message set a destination as the black box address and transmit designated status information messages including diagnosis information to the bridge 760. Then, the bridge 760 transmits the received status information messages to the black box 710. The black box 710 may generate a diagnosis information table using the received status information message and keep the diagnosis information table in a designated recording region.

Although a diagnostic apparatus is not shown in FIG. 7, the black box 710 may read the diagnosis information table from the corresponding recoding region according to request of the diagnostic apparatus and then provide the diagnosis information table. Here, the black box 710 may transmit the diagnosis information table directly to the diagnostic apparatus through wireless local communication connection or wired connection. The wireless local communication may include BlueTooth communication, WiFi, etc.

In accordance with another embodiment of the present disclosure, the diagnostic apparatus may be connected to the bridge 760. In this case, the black box 710 may receive a status information table request message from the diagnostic apparatus through the bridge 760 and transmit a diagnosis information table to the diagnostic apparatus.

Although FIG. 7 illustrates the star topology, this is one embodiment of a network structure applicable to the present disclosure. In accordance with another embodiment of the present disclosure, the black box system for vehicle diagnosis may have various network structures, such as a ring topology, a mesh topology, a tree topology, etc.

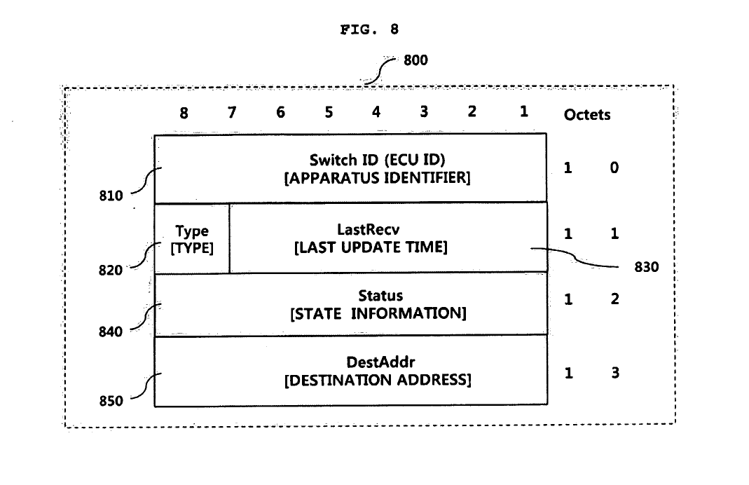

FIG. 8 is a view illustrating the structure of a status information message in accordance with one embodiment of the present disclosure. With reference to FIG. 8, a status information message 800 may include the field of an apparatus identifier (Switch ID or ECU ID) 810, the field of a type (Type) 820, the field of a last update time (LastRecv) 830, the field of status information (Status) 840, and the field of a destination address (DestAddr) 850.

The apparatus identifier 810 is apparatus identification information allocated in advance to identify a switch or an ECU on a network. The type 820 is information to identify the type of a corresponding apparatus. Here, apparatus types generally include a switch, an ECU, and a grandmaster. For example, a switch may be defined in advance as the value ‘0’, an ECU may be defined in advance as the value ‘1’, and a grandmaster may be defined in advance as the value ‘2’.

The last update time 830 means a date and time when a slave apparatus has last received an announce message from a grandmaster. The status information 840 may be diagnosis information sensed or judged by the slave apparatus and including constants defined corresponding to a normal state, a port error state, a response delay state, a power error state, and a repair requirement state.

The destination address 850 means the MAC address of the black box. The MAC address of the black box may be acquired from the announce message received from the grandmaster.

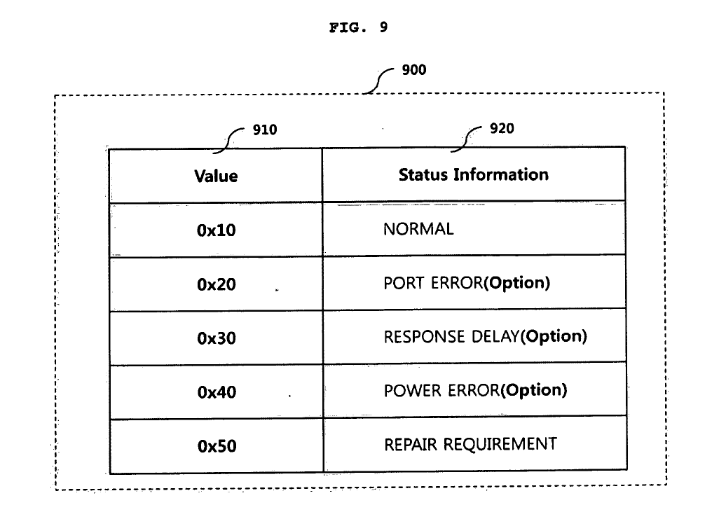

FIG. 9 is a status information mapping table in accordance with one embodiment of the present disclosure. With reference to FIG. 9, a status information mapping table 900 may be a table in which status information 920 is mapped to specific values 910.

The status information 920 may include a normal state, a port error state, a response delay state, a power error state, and a repair requirement state. Values corresponding to the respective states of the status information 920 may be defined as 0x10, 0x20, 0x30, 0x40, and 0x50. Here, the port error state, the response delay state, and the power error state may be defined as options, and the corresponding option may be used or not used in the status information message according to option setting. On the other hand, the normal state and the repair requirement state should be considered when the status information message is generated.

As one example, if option setting is established so that options are not considered, when a slave apparatus does not receive an announce message for a predetermined time, for example, for 15 seconds, the slave apparatus may judge that a communication link with a grandmaster is cut, generate a status information message in which the value of the status information 920 is set to 0x50 (the repair requirement state, and transmit the status information message to the black box 710.

On the other hand, if option setting is established so that options are considered, when the slave apparatus does not receive an announce message for a predetermined time, for example, for 2 seconds, the slave apparatus may judge that communication is delayed, generate a status information message in which the value of the status information 920 is set to 0x30 (the response delay state), and transmit the status information message to the black box 710.

The configuration of the status information mapping table 900 shown in FIG. 9 is only one embodiment, and various types of status information may be added or modified according to the configuration of the apparatus.

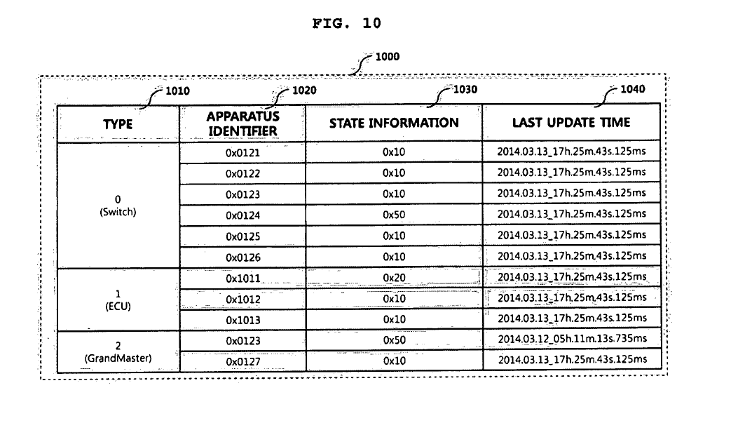

FIG. 10 is a black box diagnosis information table in accordance with one embodiment of the present disclosure. A black box diagnosis information table 1000 includes the field of a type 1010, the field of an apparatus identifier 1020, the field of status information 1030, and the field of a last update time 1040.

With reference to FIG. 10, when the black box 710 receives a status information message, the black box 710 updates the black box diagnosis information table 1000 according to the status information message. Therefore, a vehicle driver or a vehicle mechanic may intuitively confirm a result of real-time diagnosis, such as apparatus malfunction, communication link isolation, or power error, by confirming the black box diagnosis information table 1000. Therefore, a user may more rapidly confirm a cause of vehicle malfunction.

Particularly, the user may confirm which apparatus is selected as a current grandmaster and intuitively confirm change of the grandmaster. Of course, the black box diagnosis information table 1000 may be recorded in a non-volatile memory. The reason for this is that, after a vehicle accident has occurred, the black box diagnosis information table 1000 may be effectively used to confirm a cause of the accident and to prepare measures.

Particularly, since a problem, such as sudden acceleration/sudden braking of a vehicle or starting-off of a vehicle during driving, is not reproducible, it may be difficult to investigate a cause of the problem and to take measures against the problem. However, the user may confirm the black box diagnosis information table 1000 after an accident and thus may detect a correct cause of the accident.

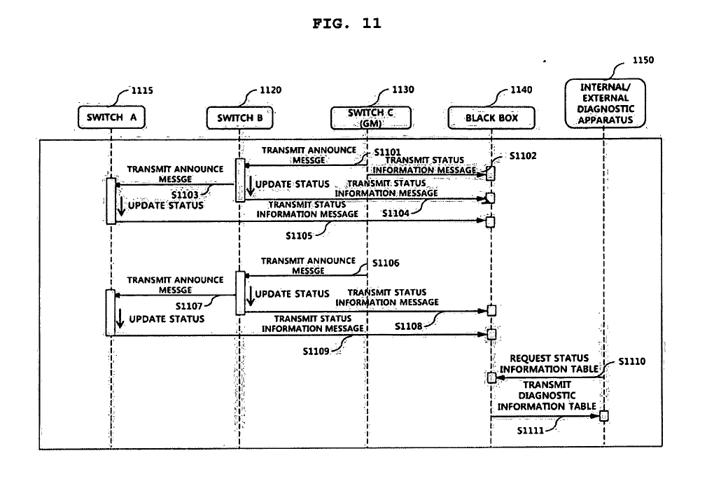

FIG. 11 is a flowchart illustrating a black box recording and diagnosis procedure through a status information message in accordance with one embodiment of the present disclosure. With reference to FIG. 11, a black box system for vehicle diagnosis in accordance with this embodiment may include a switch C 1130 selected as a grandmaster, a black box 1140 and a switch B 1120 which are connected directly to the switch C 1130, a switch A 1115 connected to the switch B 1120, and an internal/external diagnostic apparatus 1150.

As exemplarily shown in FIG. 11, when the switch C 1130 is selected as a grandmaster, the switch C 1130 transmits an announce message to the switch B 1120 and then transmits a status information message to the black box 1140 (Operation S1101 and Operation S1102).

The switch B 1120 transmits the received announce message to the switch A 1115, updates its own status, and transmits a status information message including the updated status information to the black box 1140 (Operation S1103 and Operation S1104).

When the switch A 1115 receives the announce message, the switch A 1115 updates its own status and transmits a status information message including the updated status information to the black box 1140 (Operation S1105).

Thereafter, the switch C 1130 periodically transmits an announce message to the switch B 1120, and the switch B 1120 and the switch A 1115 update their statuses according to the received announce message and transmit the updated status information to the black box 1140 through status information messages (Operation S1106 to Operation S1109). Here, the switch C 1130 selected as the grandmaster may not transmit its own status information to the black box 1140.

The black box 1140 updates the black box diagnosis information table 1000 using the received status information messages. The internal/external diagnostic apparatus 1150 may request the black box 1140 to transmit the state information table through a predetermined communication link (Operation S1110). The black box 1140 transmits the status information table to the internal/external diagnostic apparatus 1150 according to the status information table request (Operation S1111).

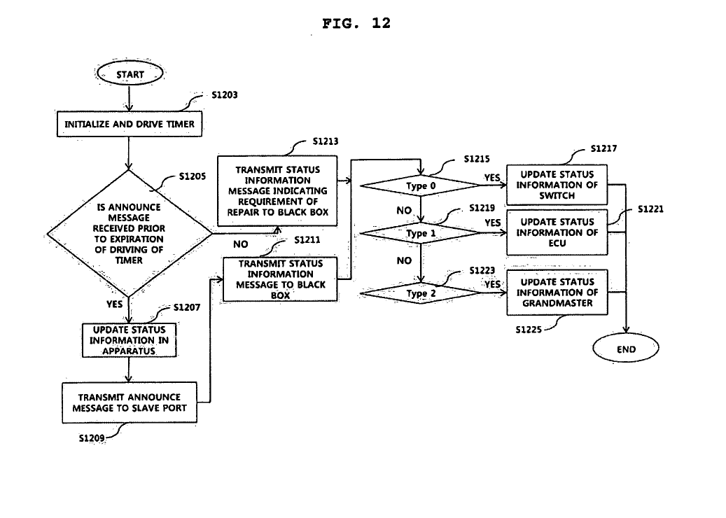

FIG. 12 is a flowchart illustrating a method for providing a black box service for vehicle diagnosis using an in-vehicle time synchronization message in accordance with one embodiment of the present disclosure.

With reference to FIG. 12, a first apparatus, which is not selected as a grandmaster and is located on the same network as the grandmaster, initializes a designated timer and drives the timer (Operation S1203). Here, the timer is driven for an announce message transmission period. When the first apparatus does not receive an announce message from the grandmaster until driving of the timer has expired, the first apparatus informs the black box of non-reception of the announce message.

When the first apparatus receives the announce message from the grandmaster prior to expiration of driving of the timer, the first apparatus resets the timer during driving and updates status information in the first apparatus (Operation S1205 to Operation S1207).

If there is a second apparatus connected to a slave port of the first apparatus, the first apparatus transmits the announce message, received in Operation S1203, to the second apparatus through the slave port (Operation S1209).

Thereafter, when update of the status information of the first apparatus has been completed, the first apparatus transmits a status information message including the updated status information to the black box 710 with reference to the black box address 610 included in the announce message, received in Operation S1203.

The black box 710 identifies the type 820 included in the received status information message and updates the black box diagnosis information table 100 according to the identified type 820 (Operation S1215 to Operation S1225). For example, the black box 710 updates switch status information when the value of the type 820 of the received status information message is ‘0’, updates ECU status information when the value of the type 820 is ‘1’, and updates grandmaster status information when the value of the type 820 is ‘2’.

In Operation S1205, if the first apparatus does not receive the announce message from the grandmaster until driving of the timer has expired, the first apparatus transmits a status information message indicating requirement of repair to the black box 710. Thereafter, the black box 710 performs Operation S1215 to Operation S1225.

As apparent from the above description, a method and apparatus in accordance with the present disclosure will have effects, as follows.

First, the present disclosure provides a black box service for vehicle diagnosis using an in-vehicle time synchronization message.

Second, the present disclosure provides a recording method of a black box for vehicle diagnosis which may perform continuous and safe self vehicle diagnosis as well as time synchronization by adding a procedure for diagnosis to a protocol procedure defined in IEEE 802.1AS.

Third, the present disclosure provides a recoding method of a black box for vehicle diagnosis which may perform self vehicle diagnosis and post-analysis by adding a format for diagnosis to an announce message between apparatuses using the same time source.

Fourth, the present disclosure provides a black box for vehicle diagnosis which may diagnose all apparatuses in a vehicle and record results of diagnosis without definition of a separate procedure by adding information for vehicle diagnosis to an announce message conventionally used for time synchronization.

Fifth, the present disclosure records diagnosis information, received from respective apparatuses according time synchronization periods, in a black box and may thus investigate a cause of an accident and prevent the accident.

Sixth, the present disclosure separately manages the status of a grandmaster and may thus compensate for IEEE 802.1AS in terms of safety.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A method for providing a black box service for vehicle diagnosis in an in-vehicle apparatus connected to a network, comprising:
confirming whether or not a time synchronization message including a black box address is received;
updating status information in the in-vehicle apparatus when the time synchronization message is received as a result of confirmation; and
transmitting a status information message including the updated status information to the black box address set as a destination address.

2. The method according to claim 1, wherein the time synchronization message is generated by a grandmaster.

3. The method according to claim 2, wherein the time synchronization message is received through a bridge connected to the grandmaster.

4. The method according to claim 3, wherein the black box address is provided to the grandmaster by the bridge.

5. The method according to claim 1, wherein the time synchronization message is formed by adding a field of the black box address to one side of an announce message format defined in IEEE 802.1AS.

6. The method according to claim 1, wherein the status information message further includes at least one of apparatus identifier information to identify the in-vehicle apparatus, type information to identify the kind of the in-vehicle apparatus, and last update time information indicating a time when the time synchronization message has been last received.

7. The method according to claim 6, wherein the kind of the in-vehicle apparatus is one of a switch, an electronic control unit (ECU), and a grandmaster.

8. The method according to claim 1, further comprising transmitting a status information message indicating whether the in-vehicle apparatus requires repair to the black box address set as the destination address, when the time synchronization message is not received for a designated time.

9. The method according to claim 1, wherein the status information is set to a value corresponding to one of a normal state, a port error state, a response delay state, a power error state, and a repair requirement state.

10. The method according to claim 9, wherein the port error state, the response delay state, and the power error state are options selectable according to an option setting.

11. The method according to claim 1, when there is another apparatus connected to the in-vehicle apparatus, further comprising transmitting the time synchronization message to the in-vehicle apparatus through a slave port of the other apparatus.

12. The method according to claim 1, wherein the black box address is a media access control (MAC) address.

13. A method for providing a black box service for vehicle diagnosis in a black box connected to an in-vehicle apparatus through a network, comprising:
transmitting address information of the black box indicating a black box address to a bridge;
receiving a status information message from the in-vehicle apparatus through the bridge; and
updating a diagnosis information table according to kinds of the in-vehicle apparatus using the status information message,
wherein, when the in-vehicle apparatus receives a time synchronization message generated by a grandmaster, the in-vehicle apparatus generates the status information message.

14. The method according to claim 13, wherein the kinds of the in-vehicle apparatus include a switch, an electronic control unit (ECU), and a grandmaster.

15. The method according to claim 13, wherein the status information message includes at least one of apparatus identifier information to identify the in-vehicle apparatus, type information to identify the kind of the in-vehicle apparatus, last update time information indicating a time when the time synchronization message has been last received, status information indicating the current status of the in-vehicle apparatus, and destination address information indicating a destination address receiving the status information message,
wherein the destination address is set according to the address information of the black box.

16. The method according to claim 15, wherein the status information is set to a value corresponding to one of a normal state, a port error state, a response delay state, a power error state, and a repair requirement state.

17. The method according to claim 13, wherein the time synchronization message is formed by adding a field of the black box address to one side of an announce message format defined in IEEE 802.1AS.

18. The method according to claim 13, further comprising:
receiving a status information table request message from a diagnostic apparatus; and
transmitting the diagnosis information table to the diagnostic apparatus.

19. A computer readable recording medium having a program recorded thereon to implement the method according to claim 1.

20. A computer readable recording medium having a program recorded thereon to implement the method according to claim 13.

21. An apparatus connected to an in-vehicle network and using the same time information, comprising:
a unit to confirm whether or not a time synchronization message including a black box address is received;
a unit to update status information in the in-vehicle apparatus when the time synchronization message is received as a result of confirmation; and
a unit to transmit a status information message including the updated status information to the black box address set as a destination address.

22. A black box connected to an in-vehicle apparatus using the same time information through a network, comprising:
a unit to transmit address information of the black box indicating a black box address to a bridge;
a unit to receive a status information message from the in-vehicle apparatus through the bridge; and
a unit to update a diagnosis information table according to kinds of the in-vehicle apparatus using the status information message,
wherein, when the in-vehicle apparatus receives a time synchronization message generated by a grandmaster, the apparatus generates the status information message.

23. A system for providing a black box service for vehicle diagnosis, comprising:
a grandmaster generating a time synchronization message including a black box address by designated periods and transmitting the time synchronization message;
an in-vehicle apparatus updating status information thereof, when the time synchronization message is received, and transmitting a status information message including the updated status information to the black box address set as a destination address; and
a black box receiving the status information message from the in-vehicle apparatus and updating a diagnosis information table.

24. The system according to claim 23, further comprising a diagnostic apparatus transmitting a status information table request message to the black box and receiving the diagnosis information table.
